(19) United States
(12) Patent Application Publication
(10) Pub. No.: US 2015/0342416 A1
(43) Pub. Date: Dec. 3, 2015

(54) PLASTIC CANISTER WITH IMPROVED STRENGTH AND A PACKAGE SYSTEM COMPRISING THE SAME

(71) Applicant: The Folger Coffee Company, Orrville, OH (US)

(72) Inventors: Darren Robling, Seville, OH (US); Gregory Peter Dalea, Hudson, OH (US)

(73) Assignee: The Folger Coffee Company, Orrville, OH (US)

(21) Appl. No.: 14/290,353

(22) Filed: May 29, 2014

(51) Int. Cl. A47J 47/04; A23F 5/10; B65D 51/20; B65D 1/16; B65D 43/02; B65D 51/16

(52) U.S. Cl. CPC A47J 47/04; B65D 43/02; B65D 51/1644; B65D 51/20; B65D 1/165; A23F 5/105; B65D 2251/0028; B65D 2251/0081; B65D 2251/009

(57) ABSTRACT

The invention provides a canister used for food product such as coffee and a packaging system comprising the same. At least 50% of the surface area of the canister sidewall is flat except it is deviated with 1-4 concaved grooves. The canister is made of a polymeric material at a usage of no more than 1.0 grams per cubic inch of the volume of the canister. When sealed, the canister can maintain its shape under a top load of at least 2.0 pounds per cubic inch of its volume and a vacuum pressure of at least 18 kPa caused by higher external pressure compared to internal pressure.

### CROSS REFERENCE TO RELATED APPLICATIONS

Not Applicable.

### FIELD OF THE INVENTION

The present invention generally relates to a canister and a packaging system useful for packing food products, and more particularly, relates to a roast and ground coffee canister and packaging system.

### BACKGROUND OF THE INVENTION

In a sophisticated food supply chain people transform natural resources, raw materials, and components into a consumable product. Typically, product is manufactured and then shipped to a warehouse where it is subsequently distributed to shops for end user customers to purchase. During this process the product packaging employed may need to satisfy a variety of requirements associated with shipping, storing, and selling the product. For example, consider coffee packaging used with coffee beans that are roasted and ground at one point of manufacture and then subsequently shipped to warehouses located anywhere around the world.

An important part of such coffee packaging may require protecting the roast and ground coffee product from various environmental contaminants (e.g., oxygen, water vapor, and dust etc.) or maintaining or extending the shelf life of the associated product. In such instances this may require using plastic canisters that are sealed with a peelable seal mounted with a one-way gas valve. In this way, gas released from the roast and ground coffee can escape but unwanted ambient air, particulates, and water vapor are prevented from backfilling into the plastic canister.

Another important part of such coffee packaging may require accommodating changing atmospheric conditions the packaging may experience as it ships from one geographical location to another as it is distributed throughout the product supply chain network (e.g., locations having altitude differences as big as 10,000 feet). In such instances, because atmospheric pressures are lower at higher altitudes (mountain passes) and higher at lower altitudes (sea level), this may require using plastic canisters that resist collapsing under vacuum. In this way, a plastic canister that incorporates a one-way gas valve, which is filled with roasted and ground coffee at sea level and then shipped to its final destination by way of a mountain pass, will not collapse upon exposure to such changes in atmospheric pressures.

Another important part of such coffee packaging may require accommodating typical warehouse conditions where packages may be stored in a building and stacked on top of each all the way to the ceiling in order to maximize efficient use of storage space. In such instances this may require using plastic canisters that have certain top load strength. In this way, a plastic canister on the ground level, which is bearing the weight of all of the containers above it, will not be deformed or damaged by such a high top load weights.

As with other commercial products, coffee packages are labeled with information communicating how to use, transport, store, recycle, or dispose of the package and/or product. The product label also provides the manufacture a means for advertising and marketing its product in order to encourage existing and potential consumers to purchase the product. Consequently, another important part of such coffee packaging may require designing a plastic coffee canister with an appropriate surface area profile so that a label can be printed thereon or attached thereto.

Last but not least, using less packaging material is not only friendly for the environment it is also cost effective for the manufacturer. Thus, another important part of such coffee packaging may require designing a plastic coffee canister that uses as little stock resin material as possible.

The delicate balance between the many requirements constitutes a challenge for the packaging engineers. For example, using less weight of stock resin in the canister necessarily makes the plastic canister weak or flimsy and likely to fail any top load requirements and/or vacuum resistance requirements. Whereas, satisfying labeling surface area requirements will inevitably constrain the packaging engineer's freedom in choosing potentially suitable designs associated with the plastic canister's three-dimensional shape.

Advantageously, the present invention provides a plastic canister, and a food package system comprising the canister, that meet one or more of the four requirements, and accomplish a fine balance between two or more of these requirements.

### SUMMARY OF THE INVENTION

One aspect of the invention provides a canister deviated or partially deviated from a standard cylinder-shaped canister. The cross section view of the standard cylinder-shaped canister along its diameter line is representable on a XY coordinated plane as 3 connected line segments including a first segment from point (R, 0) to point (−R, 0), a second segment from point (R, 0) to point (R, H), and a third segment from point (−R, 0) to point (−R, H). The central symmetrical axis of the standard cylinder-shaped canister is about the Y axis. R and H are the radius and the height of the standard cylinder-shaped canister, and the ratio R:H is in the range from 1:2.0 to 1:3.5, such as 1:2.5 to 1:2.8. There is no limitation on how the canister is deviated from the standard cylinder-shaped canister, as long as Y axis remains the central symmetrical axis of the deviated canister as well.

In various embodiments the deviation may be such that at least 50% of the length of the second/third segment being a continuous line segment deviated with 1-4 deviations thereon concaved toward Y axis, reflecting 1-4 grooves on the sidewall of the 3D canister. The deviated canister may be made of a polymeric material and the usage of the polymeric material is no more than 1.0 grams, e.g. no more than 0.9 grams, per cubic inch of the volume of the deviated canister. When sealed, the deviated canister is mechanically strong to the extent that it is capable of maintaining its shape, i.e. without deformation, under a top load of at least 2.0 pounds per cubic inch of its volume and a vacuum pressure of at least 18 kPa caused by higher external pressure compared to internal pressure.

Another aspect of the invention provides a packaging system comprising the canister as described above, and a peelable seal that seals the canister. In typical embodiment, the peelable seal includes a one-way gas valve.

Still another aspect of the invention provides a canister made from polymer resin comprising a base having a width 2B, a surrounding wall member extending vertically upward from the base having a height T, and a top opening formed at a top of the vertical wall member. The ratio of B:T is in the range from 1:2.0 to 1:3.5 and the canister has a vertical access of symmetry. A projection of a bisecting cross section of the canister coplanar with the vertical access of symmetry is representable on an XY plane as: (i) a first vertical line residing in an upper left quadrant of the XY plane defined by coordinates (0, 0), (−B, 0), (−B, T) and (0, T), wherein the first vertical line comprises a middle region, a top region located above the middle region, and a base region located below the middle region, and where the middle region contributes at least 50% to the height of the canister; (ii) a second vertical line residing in an upper right quadrant of the XY plane defined by coordinates (0, 0), (B, 0), (B, T) and (0, T), wherein the second vertical line comprises a middle region, a top region located above the middle region, and a base region located below the middle region, and where the middle region contributes at least 50% to the height of the canister; and (iii) a horizontal line extending across the upper left and upper right quadrant of the XY plane, wherein the horizontal line comprises a straight segment located between 2 end segments and the straight segment contributes at least 50% to the width of the canister. The ratio of the canister's polymer resin weight to its interior volume is no more than 1.0 gram of resin per cubic inch of volume, and the ratio of the canister's top load strength to its interior volume is at least 2.0 pounds per cubic inch of volume. Also, whereupon sealing the top opening with a closure, the sealed canister is able to withstand deformation when subject to a vacuum where atmospheric pressure outside the sealed canister is at least 18 kPa greater than atmospheric pressure inside the sealed canister.

Numerous advantages and additional aspects of the present invention will be apparent from the description of the preferred embodiments and drawings that follow.

### BRIEF DESCRIPTION OF THE DRAWINGS

While this specification includes a description of the present invention and concludes with claims that define the invention, it is believed that both will be better understood by reference to the drawings.

FIG. 1 shows a standard cylinder-shaped canister, from which the canister of the invention will be deviated from;

FIG. 2 shows the cross section view of the canister in FIG. 1 represented on a XY coordinated plane;

FIG. 3 shows an exemplary canister of the invention that is deviated from standard cylinder-shaped canister as shown in FIG. 1;

FIG. 4 shows the cross section view of canisters in FIG. 3 (in solid line) and in FIG. 1 (in dotted line) represented on a XY coordinated plane;

FIG. 5 shows another exemplary canister of the invention that is deviated from standard cylinder-shaped canister as shown in FIG. 1;

FIG. 6 shows the cross section view of canisters in FIG. 5 (in solid line) and in FIG. 1 (in dotted line) represented on a XY coordinated plane;

FIG. 7 illustrates an exemplary packaging system of the invention comprising the canister in FIG. 3;

FIG. 8 illustrates another exemplary packaging system of the invention comprising the canister in FIG. 5;

FIG. 9 shows another cross section view of canisters in FIG. 3 represented on a XY coordinated plane; and

FIG. 10 shows another cross section view of canisters in FIG. 5 represented on a XY coordinated plane.

### DETAILED DESCRIPTION OF THE INVENTION

For the purpose of promoting an understanding of the principles of the invention, reference will now be made to the embodiments illustrated in the drawings (not to scale) and specific language will be used to describe the same. It will nevertheless be understood that no limitation of the scope of the invention is thereby intended. Such alterations and further modifications in the illustrated device and such further applications of the principles of the invention as illustrated therein as would normally occur to one skilled in the art to which the invention relates are contemplated as within the scope of the invention.

Although the invention herein will generally be described in terms of a package for a food product, it should be understood that any suitable packaging system for a food product is within the scope of the present invention.

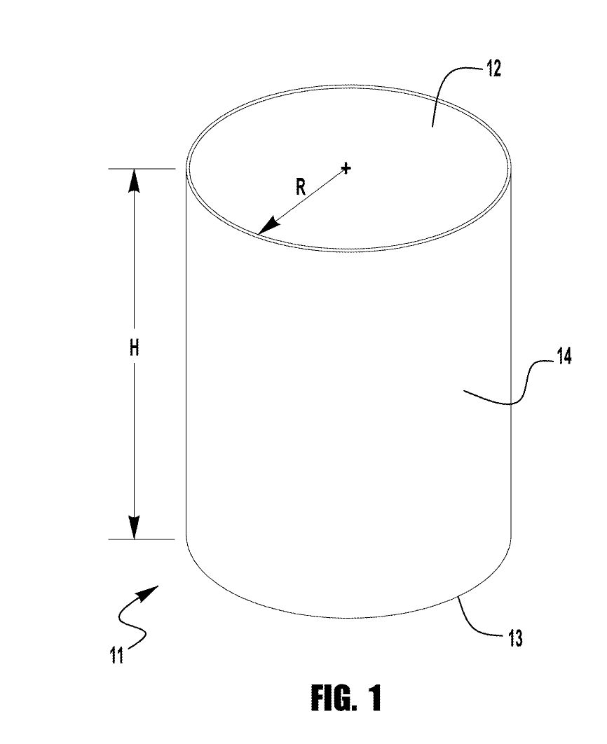

FIG. 1 shows a standard cylinder-shaped canister 11. The canister 11 generally comprises an open top 12, a closed bottom 13, and a body portion 14. The open top 12 and closed bottom 13 have a round shape with a radius, denoted as R, and body portion 14 has a height denoted as H. The open top 12, closed bottom 13, and body portion 14 define an inner volume, expressed as πR²H, in which a product such as roast and ground coffee is contained.

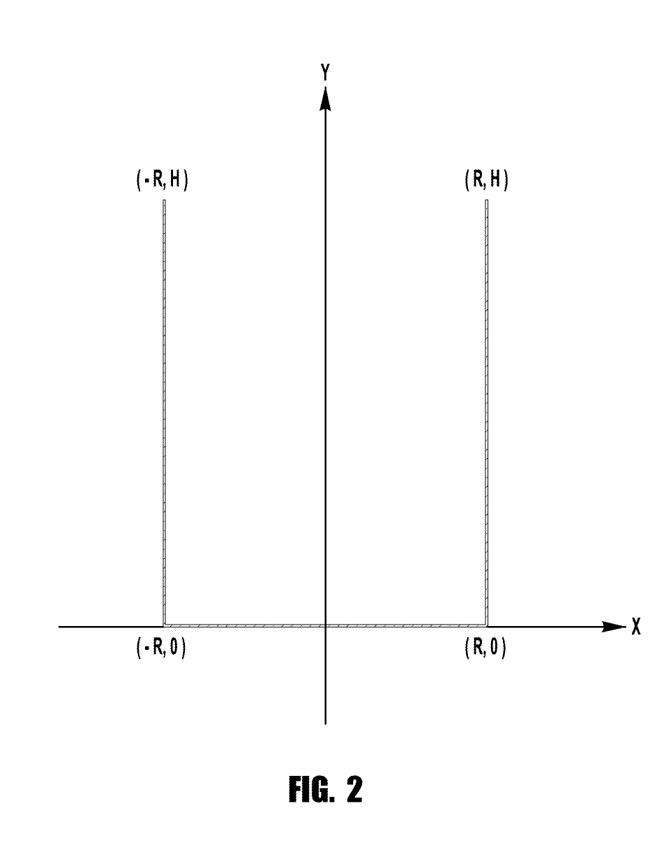

FIG. 2 shows the cross section view of canister 11 along any diameter line of the round open top 12 or bottom 13, represented on a XY coordinated plane. In the view, the canister is represented as consisting of 3 connected line segments. The first segment representing bottom 13 starts from point (R, 0) and ends at point (−R, 0). The second and third segments representing body portion 14 start from points (R, 0) and (−R, 0) and end at points (R, H) and (−R, H), respectively. The Y axis is the central symmetrical axis of the standard cylinder-shaped canister 11. R and H are the radius and the height of canister 11. The ratio R:H is preferably in the range from 1:2.0 to 1:3.5, for example, 1:2.67.

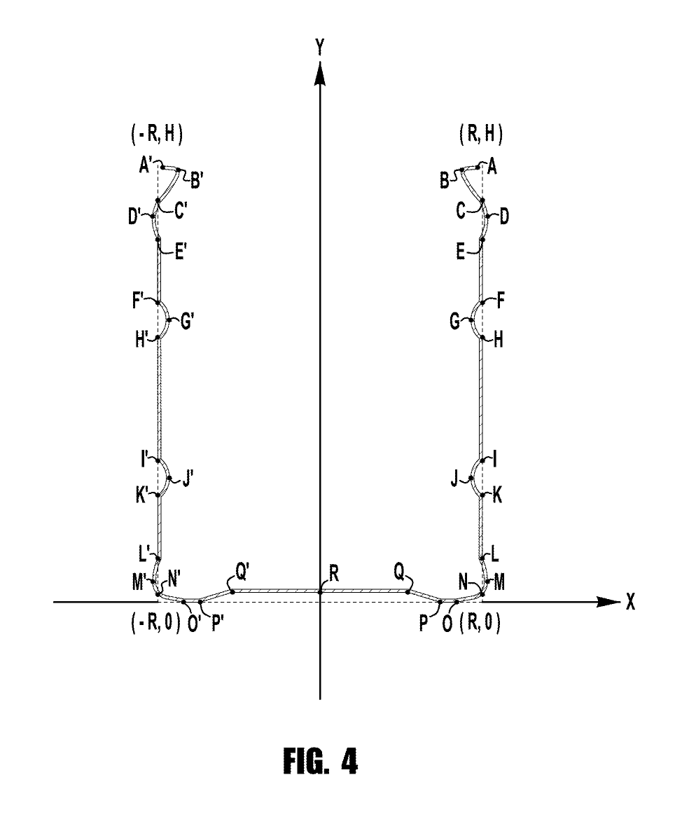

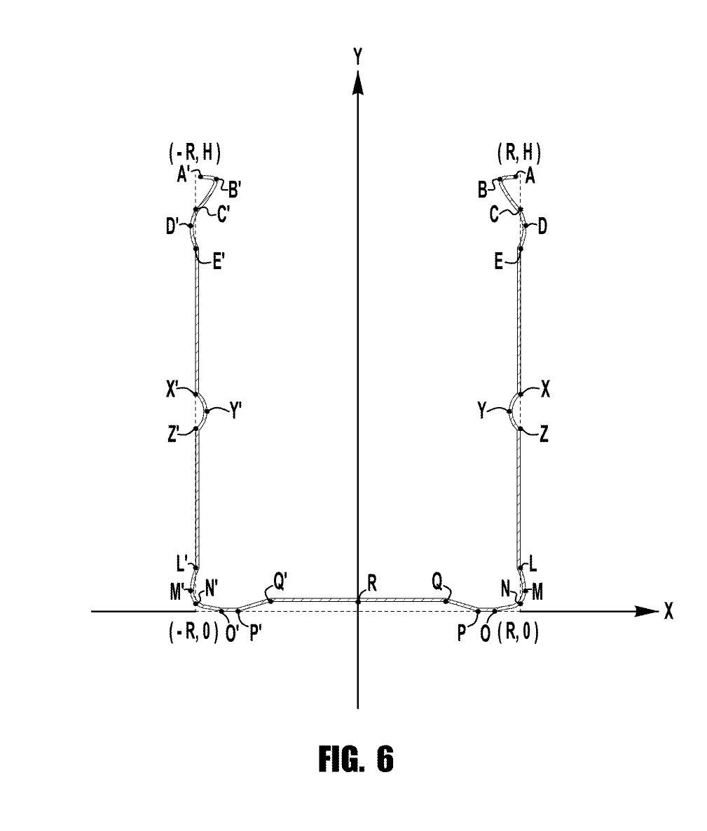

As will be described and illustrated in detail, various canisters of the present invention are deviated from the standard cylinder-shaped canister 11. There are some requirements associated with the “deviation”. First, after the deviation(s), the Y axis remains the central symmetrical axis of deviated canisters. As such, the view in quadrant II will be a mirror image of that in quadrant I. For conciseness, Applicants may sometimes refer only to quadrant I. Second, “one deviation” is intended to mean that a portion of the first or the second or the third line segments of canister 11 is moved away from its original position (i.e. deviated) and moved to one side of the corresponding line segment, provided that 1 or 2 terminal point(s) of the moved away portion remain(s) on the corresponding line segment (i.e. not deviated from its original position), and providing also that the moved away portion must remain a continuous line, which can be curved, straight, or partially curved plus partially straight. By “moved away”, it is intended to mean the portion in the first line segment is moved vertically to the side above or below the first line segment, wherein the distance between the first line segment and the farthest point away from the first line segment within the portion is less than 10% H, preferably less than 5% H. By “moved away”, it is intended to mean the portion in the second/third line segment is moved horizontally to the left or right side of the second/third line segment, wherein the distance between the second/third line segment and the farthest point away from the second/third line segment within the portion is no more than 30% R, preferably no more than 10% R. Sometimes, the deviation from the first line segment may overlap with, or merge into, that from the second/third line segment. For example, the curve from point N to point O in FIGS. 4 and 6 may be viewed as the portion moved up (or deviated) vertically from the segment between point O and point (R, 0) within the first line segment, it may also be viewed as the portion moved (or deviated) horizontally to the left side from the segment between point N and point (R, 0) within the second line segment. Third, after deviation(s), the first segment still remains connected to the second segment in a continuous manner and it also remains connected to the third segment in a continuous manner. As shown in FIGS. 4 and 6, the first line segment is connected to the second/third line segment via the curve passing point O, N, and M or the curve passing O′, N′ and M′. Fourth, after deviation(s), there remains no direct connection between the second segment and the third segment and instead they connect to each other via the first line segment. Fifth, the moved away (or deviated) portion can be comprised of a part perpendicular to the corresponding line segment. For example, the curve passing points A, B and C can be viewed as deviated from the straight line segment between point C and point (R, H). Sometimes, A and B may be connected by a straight line that is perpendicular to the line defined as X=R (i.e. the second line segment) and the entire line segment AB may be viewed as deviated from a single point (R, H).

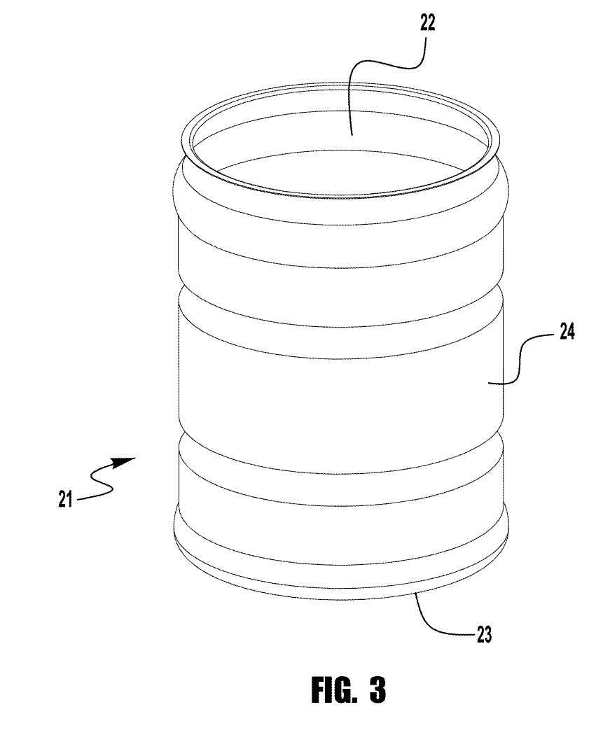

FIG. 3 shows an exemplary canister 21 of the invention that is deviated from the standard cylinder-shaped canister 11 as shown in FIG. 1. Canisters 11 and 21 share the same central symmetrical axis. Like canister 11, canister 21 generally comprises an open top 22, a closed bottom 23, and a body portion 24. FIG. 4 shows the cross section view of canister 21 (in solid line) along any diameter line of the round open top 22 or bottom 23, as represented on a XY coordinated plane. For comparison, the cross section view of canister 11 (in dotted line) as shown in FIG. 1 is also included in FIG. 4. As shown in FIG. 4, the Y axis remains the central symmetrical axis of both canisters 11 and 21.

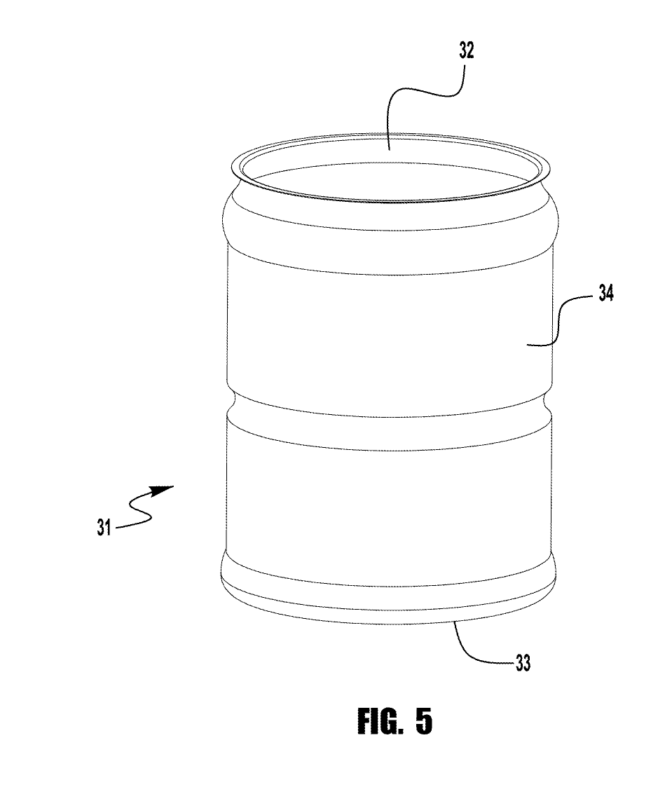

FIG. 5 shows another exemplary canister 31 of the invention that is deviated from the standard cylinder-shaped canister 11 as shown in FIG. 1. Canisters 11 and 31 share the same central symmetrical axis. Like canister 11, canister 31 generally comprises an open top 32, a closed bottom 33, and a body portion 34. FIG. 6 shows the cross section view of canister 31 (in solid line) along any diameter line of the round open top 32 or bottom 33, as represented on a XY coordinated plane. For comparison, the cross section view of canister 11 (in dotted line) as shown in FIG. 1 is also included in FIG. 6. As shown in FIG. 6, Y axis remains the central symmetrical axis of both canisters 11 and 31.

In various embodiments, the deviation may be such that at least 50% (or such that at least 65%) of the length of the second/third segment being a continuous line segment deviated with from 1-4 deviations thereon that are concaved toward Y axis, representative of from 1-4 grooves on the sidewall of the 3D canister, for example, on the canister's body portions 24 and 34. In preferred embodiments, this continuous line segment represents the area where a label (not shown) can be applied. The label is used to communicate how to use, transport, store, recycle, or dispose of the canister and the product such as coffee contained therein. The label can also be used for marketing communications and for encouraging potential buyers to purchase the product. For example, as illustrated in FIG. 4 and FIG. 6, the distance between points E and L, which can be used for labeling, is at least 50% (e.g. 71.6%) of the length of the second/third segment as defined above. In FIG. 4, the straight and continuous line segment between points E and L of canister 11 is deviated with 2 deviations reflecting two 3D grooves, one passing points F, G and H (hereinafter, referred to as Groove FGH) and another passing points IJK (hereinafter, referred to as Groove IJK). In FIG. 6, the straight line segment between points E and L of canister 11 is deviated with one deviation reflecting one 3D groove passing points X, Y and Z (hereinafter, referred to as Groove XYZ). As shown in FIGS. 4 and 6, Grooves FGH, IJK and XYZ are all concaved toward the Y axis.

The deviated canister of the invention such as canisters 21 and 31 may be made of any suitable polymeric material. The amount of the polymeric material used to make the canister is typically no more than 1.0 grams per cubic inch of the volume of the deviated canister. In preferred embodiments, the amount of the polymeric material used for a canister is about 0.84 grams per cubic inch of the volume of deviated canister, for each of canisters 21 and 31. In preferred embodiments, the polymeric material is a laminated structure comprising HDPE/EVOH/HDPE. In preferred embodiments, the polymeric material is a laminated structure comprising HDPE/regrind/adhesive/EVOH/adhesive/HDPE. The interior HDPE touches the coffee. Regrind is composed of a part of the outside layer of the laminated structure (e.g., HDPE). The HDPE typically has a colorant included.

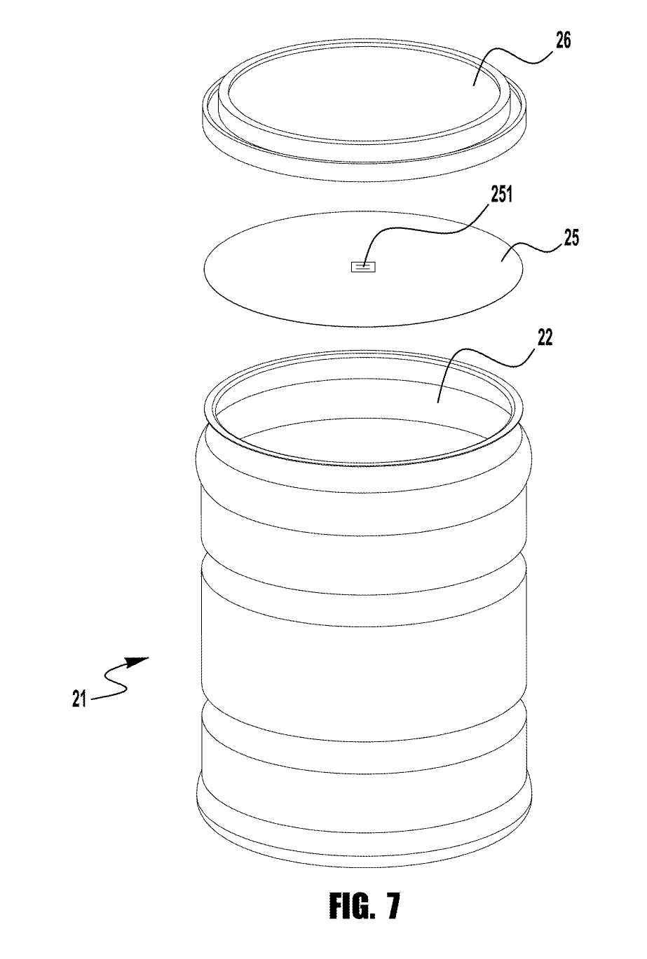

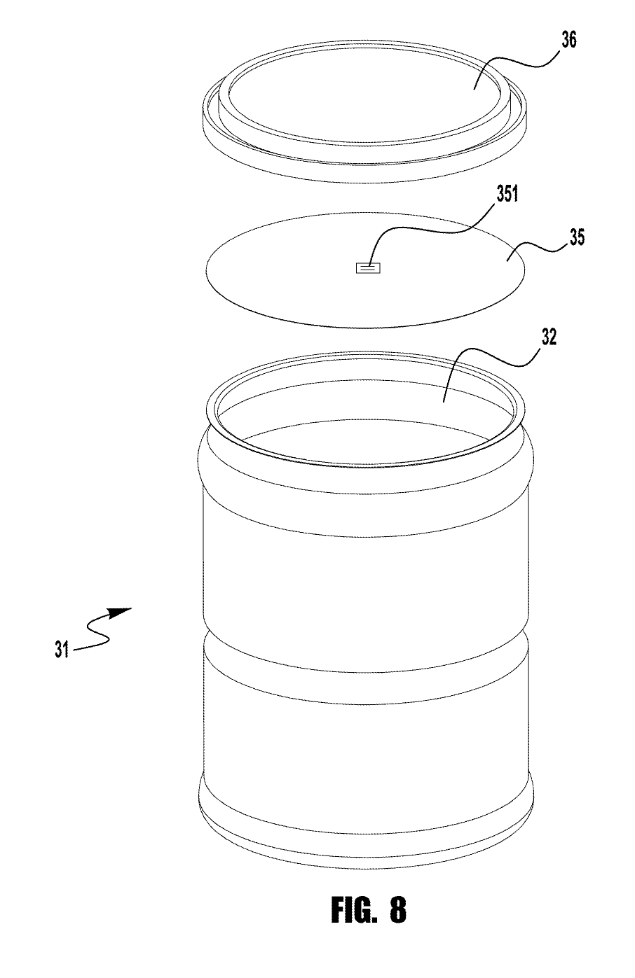

The invention further provides a packaging system comprising a canister as described above (e.g. 21 or 31), and a removable, peelable seal that seals the canister. With reference to FIGS. 7 and 8, these two figures show two examples of the packaging system. Open tops 22 and 32 of canisters 21 and 22 are sealed with the removable, peelable seals 25 and 35 respectively. Mounted on peelable seals 25 and 35 are one-way gas valves 251 and 351. For example, peelable seals 25 and 35 can have a laminated structure, and can be removeably attached and sealed to canisters 21 and 22. Peelable seals 25 and 35 can have a hole beneath onto which can be applied a one-way degassing valve, indicated as a hole by reference number 251 or 351. One-way valve 251 or 351 can be attached in a variety of way, including by being heat welded or glued to peelable seal 25 or 35.

Overcaps 26 and 36 can be configured to be removeably attached to canisters 21 and 22. They can cover peelable seals 25 and 26 respectively to provide further protection. As a non-limiting example, overcaps 26 and 36 are generally manufactured from a plastic with a low flexural modulus, for example, linear low-density polyethylene (LLDPE), low-density polyethylene (LDPE), high-density polyethylene (HDPE), polyethylene (PE), polypropylene (PP), linear low-density polyethylene (LLDPE), polycarbonate, polyethylene terephthalate (PET), polystyrene, polyvinyl chloride (PVC), co-polymers thereof, and combinations thereof. This allows for an overcap 26 or 36 that has a high degree of flexibility yet can still provide sufficient rigidity to allow stacking of successive canisters. By using a flexible overcaps 26 and 36, mechanical application during packaging as well as re-application of overcaps to canisters after opening by the consumer is facilitated.

In preferred embodiments, the packaging system of the invention includes a coffee product such as roast and ground coffee contained in canisters such as 21 and 31.

When deviated canisters 21 and 31 are filled with a food product such as coffee, and their open tops 22 and 32 sealed with peelable seals 25 and 35, these canisters are mechanically strong to such an extent that they are capable of maintaining their shape (i.e. without deformation) under a top load of at least 2.0, preferably 2.2-5.0 such as 2.3-2.4 and 3.2-4.0, pounds per cubic inch of their volumes. At the same time, canisters 21 and 31 can also withstand (i.e. does not collapse) a vacuum pressure caused by the one-way gas valve and an altitude change of as big as 10,000 feet such as 5600 feet, during the shipment of the packaging system. In various embodiments, canisters 21 and 31 can withstand a vacuum pressure of at least 18 kPa (e.g. 24 kPa) caused by higher external pressure compared to internal pressure.

Referring back to FIGS. 4 and 6, the labeling area, i.e. the so-called at least 50% of the length of the second/third segment, or more specifically the segment from point E to point L, is located in the middle region (hereinafter region EL) of the second/third segment. A top region from point A to point E (hereinafter region AE) is located above region EL and a base region from point L to point O (hereinafter region LO) is located below middle region EL. The sum of the heights of regions AE, EL and LO is equal to the length of the second/third segment, H. In various embodiments, the height ratio between top region AE and base region LO is from 1:0.60 to 1:0.80, for example, 1:0.68.

In preferred embodiments, top region AL is completely deviated from the standard cylinder-shaped canister 11 as shown in FIG. 1, except two overlapping points C and E. For example, top region AL may consist of two deviations: one passing points ABC and another CDE. Points B and D are the peak points of deviations ABC and CDE. By peak point, it is intended to define that it has the longest distance from the line segment from point (R, H) to point (R, 0) within the deviation it locates. For example, peak point B has the longest distance away from the line segment from point (R, H) to point (R, 0) within deviation ABC. By the same token, peak point D has the longest distance away from the line segment from point (R, H) to point (R, 0) within deviation CDE. Deviation CDE is adjacent to middle region EL, and may be a convex deviation reflecting a 3D groove away from Y axis (hereinafter “convex grove”). The base length of the convex groove (i.e. straight distance between C and E) may be 6-14% H such as 8-12% H, e.g. 10.4% H. The depth of the convex groove (i.e. the distance between peak point D and line X=R) is 1-6% R such as 4-5% R, e.g. 4.4% R.

Deviation ABC is located above deviation CDE, and may be a concave deviation (either symmetrical or unsymmetrical) toward Y axis. Unlike deviation CDE's terminal points C and E, point A is not only a terminal point of deviation ABC, it is also the terminal point of the entire side wall of canisters 21 and 31. As such, point A does not have to resume its un-deviated position (R, H) or (−R, H). The base length of the concave deviation (i.e. distance between C and point (R, H) may be in the range of 6-14% H such as 6-7% H, e.g. 6.5% H, and the depth of the concave groove (i.e. between peak point B and line X=R) is 2-10% R such as 6-8% R, for example 7% R. Although in FIGS. 4 and 6, the concave deviation ABC in quadrant I of the XY coordinated plane starts from point A (0.97R, H), passes peak point B (0.93R, H), and ends at point C (R, 0.935H), it should be understood that point A may have a coordinate (X1, H), wherein X1=(0.7˜1.3)R. In those embodiments, the region above point C may have 1 or 2 deviations, depending on whether X1≦R or X1>R, and the peak point may be A or B or both, depending upon the position of A relative to B and to line X=R. But anyway, that region may be broadly defined as a deviation (or deviations) starting from point A (X1, H), passing B (0.93R, H), and ends at C on line X=R. It should be understood that A and B may also be merged into one point. In preferred embodiments, segment AB provides an area that can be commonly called a rim, either outwardly or inwardly oriented. The rim can be used to attach seals 25 and 35, as shown in FIGS. 6 and 7.

Referring again to FIGS. 4 and 6, like top region AE, base region LO may also be completely deviated from the standard cylinder-shaped canister 11. For example, region LO may consist of two deviations, one of which is deviation LMN adjacent to middle region EL. Deviation LMN may be convex deviation away from Y axis having base length (i.e. distance between L and N) of 6-14% H such as 9-10% H, e.g. 9.6%, and a depth (i.e. distance between peak point M and line X=R) of 1-6% R such as 4-5% R, e.g. 4.4% R.

As described above, the first segment representing bottom 13 in FIG. 2 starts from point (R, 0) and ends at point (−R, 0). The bottom of the canister according to the invention comprises at least one deviation. As shown in FIGS. 4 and 6, deviation PQRQ′P′ is a concave toward the center of the canister and has an isosceles trapezoid shape. The isosceles trapezoid shape has a bottom base length (i.e. distance from P to P′) of 73-76% D, a top base length (i.e. distance from Q to Q′) of 55-58% D, and a height (i.e. distance from point R to line Y=0) of 1-2% H, wherein D=2R. In an exemplary embodiment, the isosceles trapezoid shape has a bottom base length of 74.4% D, a top base length of 56.4% D, and a height of 1.6% H.

Referring back to FIGS. 4 and 6, and as described above, region EL is the labeling area for the canister of the invention, and can have 1-4 concave deviations. In typical embodiments, 10-40% such as 12-28% of the straight line segment between E and L (or along the height of region EL) of is deviated in any manner, for example, about 26.9% as shown in FIG. 4, and about 13.4% as shown in FIG. 6.

With reference to FIG. 4, region EL includes two and only two deviations FGH and IJK, all being concave deviations reflecting 3D grooves toward the Y axis. Although FIG. 4 shows that the two deviations have same geometrical profile, they can have different geometrical profile as well. The two concave deviations may have a base length (i.e. distance between F and H or I and K) of 6-14% H such as 9-10% H e.g. 9.6% H, and a depth (i.e. distance between peak points G or J to line X=R) of 1-6% R such as 4-5% R e.g. 4.4% R.

In typical embodiments, deviations FGH and IJK are separated from each other, but they can be next to each other as well, i.e. H and I being merged into one point. In FIG. 4, region EL has 3 un-deviated straight line segments EF, HI and KL divided by two deviations FGH and IJK. Segment HI may have a length of Lm in the range of 14-16% H such as 14.8% H. Top segment EF may have a length of (0.5-0.7)×Lm, such as 0.57×Lm. Bottom segment KL may have a length of (0.4-0.6)×Lm, such as 0.49×Lm.

In a specific embodiment of the invention, as shown in FIG. 4, the values of H and R are 5.2 inch and 1.95 inch respectively. The deviated canister 21 is made of a laminated structure comprising HDPE/EVOH/HDPE at a usage of 45-58 grams, and has a specific thickness profile. In quadrant I of the XY coordinated plane as shown in FIG. 4, deviated canister 21 in the unit of inch starts from point A (1.9, 5.2) having a thickness of 0.02-0.04, which is connected via a straight line to point B (1.815, 5.19) having a thickness of 0.02-0.04, which is connected via a curved line to point C (1.95, 4.86) having a thickness of 0.02-0.04, which is connected via a curved line to point D (2.035, 4.6) having a thickness of 0.03-0.05, which is connected via a curved line to point E (1.95, 4.32) having a thickness of 0.03-0.05, which is connected via a straight line to point F (1.95, 3.55) having a thickness of 0.03-0.05, which is connected via a curved line to point G (1.865, 3.3) having a thickness of 0.03-0.05, which is connected via a curved line to point H (1.95, 3.05) having a thickness of 0.03-0.05, which is connected via a straight line to point I (1.95, 1.7) having a thickness of 0.03-0.05, which is connected via a curved line to point J (1.865, 1.45) having a thickness of 0.03-0.05, which is connected via a curved line to point K (1.95, 1.2) having a thickness of 0.03-0.05, which is connected via a straight line to point L (1.95, 0.6) having a thickness of 0.02-0.05, which is connected via a curved line to point M (2.035, 0.35) having a thickness of 0.02-0.05, which is connected via a curved line to point N (1.95, 0.1) having a thickness of 0.03-0.06, which is connected via a curved line to point O (1.85, 0) having a thickness of 0.03-0.06, which is connected via a straight line to point P (1.45, 0) having a thickness of 0.03-0.06, which is connected via a straight line to point Q (1.1, 0.085) having a thickness of 0.03-0.06, which is connected via a straight line to point R (0, 0.085) having a thickness of 0.03-0.06.

With reference to FIG. 6, region EL includes one and only one deviation XYZ, a concave deviation reflecting 3D groove toward Y axis. Concave deviation XYZ may have a base length (i.e. distance from X to Z) of 6-14% H such as 9-10% H e.g. 9.6% H, and a depth (i.e. distance from Y to line X=R) of 1-6% R such as 4-5% R e.g. 4.4% R. As a result, middle region EL has 2 un-deviated straight line segments EX and ZL divided by deviation XYZ. While top segment EX may have a length of Lt in the range of 32-36% H such as 34% H, bottom segment ZL may have a length of (0.7-0.9)×Lt, such as 0.82×Lt.

In a specific embodiment of the invention, as shown in FIG. 6, the values of H and R are 5.2 inch and 1.95 inch respectively. The deviated canister 31 is made of a laminated structure comprising HDPE/EVOH/HDPE at a usage of 45-58 grams. In quadrant I of the XY coordinated plane as shown in FIG. 6, deviated canister 31 in the unit of inch starts from point A (1.9, 5.2) having a thickness of 0.02-0.04, which is connected via a straight line to point B (1.815, 5.19) having a thickness of 0.02-0.04, which is connected via a curved line to point C (1.95, 4.86) having a thickness of 0.02-0.04 which is connected via a curved line to point D (2.035, 4.6) having a thickness of 0.03-0.05, which is connected via a curved line to point E (1.95, 4.32) having a thickness of 0.03-0.05, which is connected via a straight line to point X (1.95, 2.55) having a thickness of 0.03-0.05, which is connected via a curved line to point Y (1.865, 2.3) having a thickness of 0.03-0.05, which is connected via a curved line to point Z (1.95, 2.05) having a thickness of 0.03-0.05, which is connected via a straight line to point L (1.95, 0.6) having a thickness of 0.02-0.05, which is connected via a curved line to point M (2.035, 0.35) having a thickness of 0.02-0.05, which is connected via a curved line to point N (1.95, 0.1) having a thickness of 0.03-0.06, which is connected via a curved line to point O (1.85, 0) having a thickness of 0.03-0.06, which is connected via a straight line to point P (1.45, 0) having a thickness of 0.03-0.06, which is connected via a straight line to point Q (1.1, 0.085) having a thickness of 0.03-0.06, which is connected via a straight line to point R (0, 0.085) having a thickness of 0.03-0.06.

In connection to FIGS. 4 and 6, the straight line segment between A and B represents a protuberance, in the form of a rim like structure, disposed at the open end of canisters 21 and 31. Such protuberance may have textured surfaces disposed thereon. Textured surfaces disposed on the protuberance can comprise raised surfaces in the form of protuberances, annular features, and/or cross-hatching to facilitate better sealing of removable or peelable seals 25 and 35. Annular features may include a single bead or a series of beads as concentric rings protruding from the seal surface of the protuberance. While not wishing to be bound by theory, it is believed that a textured surface on protuberance can allow for the application of a more uniform and/or concentrated pressure during a sealing process. Textured surfaces can provide increased sealing capability between protuberance and seals 25 and 35 due to any irregularities introduced during molding, trimming, shipping processes, and the like during manufacture of canisters 21 and 31. It should be understood that while FIGS. 4 and 6, as well as other embodiments disclose a protuberance, packaging systems without a protuberance (e.g. A and B are merged into one point) are contemplated and within the scope of this invention.

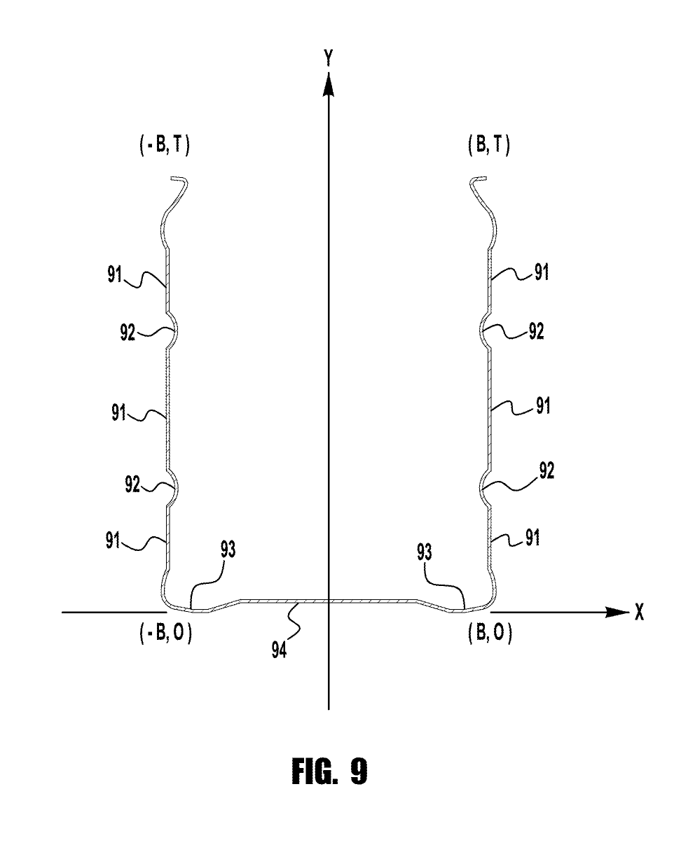

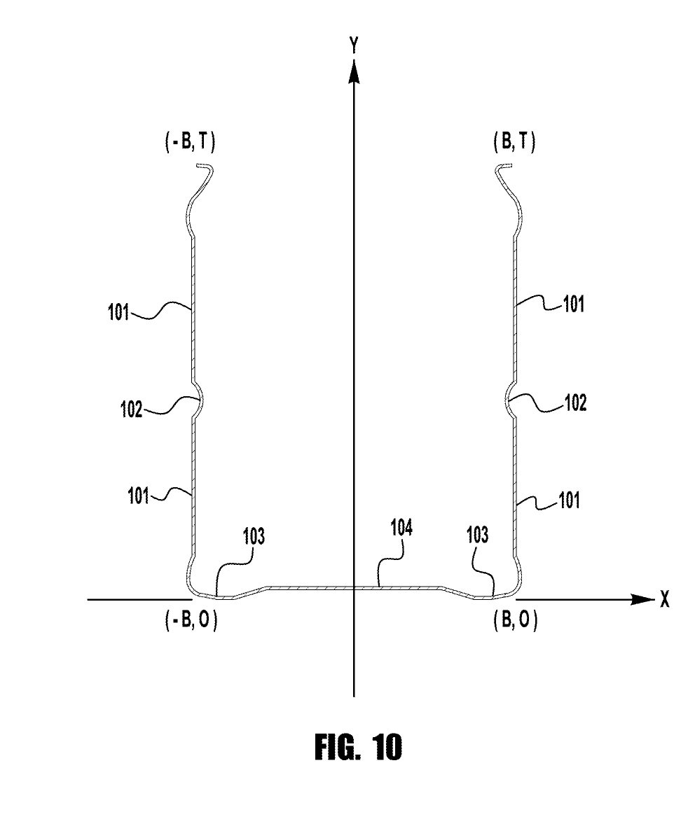

FIGS. 9 and 10 show two exemplary canisters of the invention. FIGS. 9 and 10 show the cross section views of the canisters along any diameter line of the open top or bottom, represented on a XY coordinated plane. As shown in FIGS. 9 and 10, the Y axis remains the central symmetrical axis of the canister. Canisters are made from polymer resin comprise a base having a width 2B, a surrounding wall member extending vertically upward from the base having a height T, and a top opening formed at a top of the vertical wall member, wherein the ratio B:T is in the range from 1:2.0 to 1:3.5. The canisters have a vertical access of symmetry. Projection of a bisecting cross section of the canister coplanar with the vertical access of symmetry is representable on an XY plane as (i) a first vertical line residing in an upper left quadrant of the XY plane defined by coordinates (0, 0), (−B, 0), (−B, T), and (0, T), wherein the first vertical line comprises a middle region, a top region located above the middle region, and a base region located below the middle region, wherein the middle region contributes at least 50% to the height of the canister; (ii) a second vertical line residing in an upper right quadrant of the XY plane defined by coordinates (0, 0), (B, 0), (B, T), and (0, T), wherein the second vertical line comprises a middle region, a top region located above the middle region, and a base region located below the middle region, wherein the middle region contributes at least 50% to the height of the canister; and (iii) a horizontal line extending across the upper left and upper right quadrant of the XY plane, wherein the horizontal line comprises a straight segment (94 in FIG. 9 or 104 in FIG. 10) located between 2 end segments, the straight segment contributes at least 50% to the width of the canister. The ratio of the canister's polymer resin weight to interior volume is no more than 1.0 gram of resin per cubic inch of volume. The ratio of the canister's top load strength to interior volume is at least 2.0 pounds per cubic inch of volume. Upon sealing the top opening with a closure, the sealed canister is able to withstand deformation when subject to a vacuum where atmospheric pressure outside the sealed canister is at least 18 kPa greater than atmospheric pressure inside the sealed canister. The invention further provides packaging system comprising the canister, a removable, peelable seal that seals the top opening wherein the removable, peelable seal includes a one-way gas valve, and an overcap covering the removable, peelable seal.

In an embodiment as shown in FIG. 9, the middle region of the first vertical line comprises 3 straight segments 91 and 2 curved segments 92 concaving inward towards the vertical access of symmetry, wherein each curved segment 92 is adjacent to 2 straight segments 91. The middle region of the second vertical line comprises 3 straight segments 91 and 2 curved segments 92 concaving inward towards the vertical access of symmetry, wherein each curved segment 92 is adjacent to 2 straight segments 91. In an embodiment, the ratio of contribution to the height of the canister from the top region to that from the base region is from 1:0.60 to 1:0.80. The polymer resin may be for example a laminated structure comprising HDPE/EVOH/HDPE.

In an embodiment as shown in FIG. 10, the middle region of the first vertical line comprises 2 straight segments 101 and a curved segment 102 concaving inward towards the vertical access of symmetry, wherein the curved segment 102 is adjacent to each of the 2 straight segments 101. The middle region of the second vertical line comprises 2 straight segments 101 and a curved segment 102 concaving inward towards the vertical access of symmetry, wherein the curved segment 102 is adjacent to each of the 2 straight segments 101. In an embodiment, the ratio of contribution to the height of the canister from the top region to that from the base region is from 1:0.60 to 1:0.80. The polymer resin may be for example a laminated structure comprising HDPE/EVOH/HDPE.

With respect to manufacturing, canisters of the present invention can be produced by blow molding a polyolefinic compound. Polyethylene and polypropylene, for example, are relative low cost resins suitable for food contact and provide an excellent water vapor barrier. However, in certain situations these materials may not be adequate for packaging oxygen-sensitive foods requiring a long shelf life. As a non-limiting example, ethylene vinyl alcohol (EVOH) can provide a superior barrier material in certain instances. Thus, a thin layer of EVOH sandwiched between two or more polyolefinic layers can be used in certain situations to solve this problem. Therefore, the blow-molding process can be used with multi-layered structures by incorporating additional extruders for each resin used. Additionally, the container can be manufactured using other methods, including injection molding and stretch blow molding.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “1.95 inch” is intended to mean “about 1.95 inch”.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A canister deviated from a standard cylinder-shaped canister having central symmetrical axis,
wherein the deviated canister and said standard cylinder-shaped canister share the same central symmetrical axis;
wherein the cross section view of the standard cylinder-shaped canister along a diameter line thereof is representable on a XY coordinated plane as 3 connected line segments including a first segment from point (R, 0) to point (−R, 0), a second segment from point (R, 0) to point (R, H), and a third segment from point (−R, 0) to point (−R, H), wherein Y axis is the central symmetrical axis of the standard cylinder-shaped canister; R and H are the radius and the height of the standard cylinder-shaped canister, and the ratio R:H is in the range from 1:2.0 to 1:3.5;
wherein at least 50% of the length of the second/third segment in the cross section view of the standard cylinder is deviated with 1-4 deviations concaved toward Y axis to form the deviated canister;
wherein the deviated canister is made of a polymeric material, and the usage of the polymeric material is no more than 1.0 grams per cubic inch of the volume of the deviated canister; and
wherein the deviated canister can maintain its shape under a top load of at least 2.0 pounds per cubic inch of its volume; and
wherein the deviated canister, when sealed, can maintain its shape under a vacuum pressure of at least 18 kPa caused by higher external pressure compared to internal pressure.

2. The canister according to claim 1, wherein the polymeric material is a laminated structure comprising HDPE/EVOH/HDPE.

3. The canister according to claim 1, wherein said at least 50% of the length of the second/third segment is located in the middle region of said second/third segment; wherein a top region is located above the middle region and a base region is located below the middle region, and the sum of the heights of the top, middle and base regions is equal to the length of said second/third segment.

4. The canister according to claim 3, wherein the height ratio between the top region and the base region is from 1:0.60 to 1:0.80.

5. The canister according to claim 1, wherein the first segment representing the bottom of the canister comprises at least one deviation.

6. The canister according to claim 3, wherein 10-40% such as 12-28% of the line segment of said middle region is deviated.

7. The canister according to claim 6, wherein the line segment of said middle region has only two deviations.

8. The canister according to claim 7, wherein said two deviations have same geometrical profile.

9. The canister according to claim 8, wherein said two deviations have a base length of 6-14% H, and a depth of 1-6% R.

10. The canister according to claim 7, wherein the line segment of said middle region has 3 un-deviated straight line segments divided by said two deviations.

11. The canister according to claim 10, wherein the middle one of said 3 un-deviated straight line segments has a length of Lm in the range of 10-16% H such as 14-16% H.

12. The canister according to claim 11, wherein the top one of said 3 un-deviated straight line segments has a length of (0.5-0.7)×Lm.

13. The canister according to claim 11, wherein the bottom one of said 3 un-deviated straight line segments has a length of (0.4-0.6)×Lm.

14. The canister according to claim 6, wherein the line segment of said middle region has only one deviation.

15. The canister according to claim 14, wherein said one deviation has a base length of 9-10% H, and a depth of 1-6% R.

16. A packaging system comprising the canister according to claim 1, and a peelable seal that seals the canister, wherein the peelable seal includes a one-way gas valve.

17. The packaging system according to claim 16, further comprising an overcap covering the peelable seal.

18. The packaging system according to claim 16, further comprising a coffee product contained in the canister.

19. The packaging system according to claim 18, wherein the coffee product is roast and ground coffee.

20. A canister made from polymer resin comprising a base having a width 2B, a surrounding wall member extending vertically upward from the base having a height T, and a top opening formed at a top of the vertical wall member,
wherein the ratio B:T is in the range from 1:2.0 to 1:3.5,
wherein the canister has a vertical access of symmetry,
wherein projection of a bisecting cross section of the canister coplanar with the vertical access of symmetry is representable on an XY plane as:
(i) a first vertical line residing in an upper left quadrant of the XY plane defined by coordinates (0, 0), (−B, 0), (−B, T), and (0, T), wherein the first vertical line comprises a middle region, a top region located above the middle region, and a base region located below the middle region, wherein the middle region contributes at least 50% to the height of the canister;
(ii) a second vertical line residing in an upper right quadrant of the XY plane defined by coordinates (0, 0), (B, 0), (B, T), and (0, T), wherein the second vertical line comprises a middle region, a top region located above the middle region, and a base region located below the middle region, wherein the middle region contributes at least 50% to the height of the canister;
(iii) a horizontal line extending across the upper left and upper right quadrant of the XY plane, wherein the horizontal line comprises a straight segment located between 2 end segments, the straight segment contributes at least 50% to the width of the canister,
wherein the ratio of the canister's polymer resin weight to interior volume is no more than 1.0 gram of resin per cubic inch of volume, and
wherein the ratio of the canister's top load strength to interior volume is at least 2.0 pounds per cubic inch of volume, and
whereupon sealing the top opening with a closure, the sealed canister is able to withstand deformation when subject to a vacuum where atmospheric pressure outside the sealed canister is at least 18 kPa greater than atmospheric pressure inside the sealed canister.

21. The canister according to claim 20,
wherein the middle region of the first vertical line comprises 3 straight segments and 2 curved segments concaving inward towards the vertical access of symmetry, wherein each curved segment is adjacent to 2 straight segments, and
wherein the middle region of the second vertical line comprises 3 straight segments and 2 curved segments concaving inward towards the vertical access of symmetry, wherein each curved segment is adjacent to 2 straight segments.

22. The canister according to claim 20,
wherein the middle region of the first vertical line comprises 2 straight segments and a curved segment concaving inward towards the vertical access of symmetry, wherein the curved segment is adjacent to each of the 2 straight segments, and
wherein the middle region of the second vertical line comprises 2 straight segments and a curved segment concaving inward towards the vertical access of symmetry, wherein the curved segment is adjacent to each of the 2 straight segments.

23. The canister according to claim 21, wherein the ratio of contribution to the height of the canister from the top region to that from the base region is from 1:0.60 to 1:0.80.

24. The canister according to claim 22, wherein the ratio of contribution to the height of the canister from the top region to that from the base region is from 1:0.60 to 1:0.80.
